(19) United States
(12) Patent Application Publication
(10) Pub. No.: US 2004/0257360 A1
(43) Pub. Date: Dec. 23, 2004

(54) Method and device for producing light-microscopy, three-dimensional images

(76) Inventor: Frank Sieckmann, Bochum (DE)

Correspondence Address: Davidson Davidson & Kappel, 485 Seventh Avenue, 14th Floor, New York, NY, 10018, US

(21) Appl. No.: 10/493,271

(22) PCT Filed: Oct. 14, 2002
(86) PCT No.: PCT/EP02/11458

(30) Foreign Application Priority Data
Oct. 22, 2001 (DE) 101 51 285.6
Aug. 16, 2002 (DE) 102 37 470.8

(51) Int. Cl. G06T 15/00

(52) U.S. Cl. 345/419

(57) ABSTRACT

The invention relates to a device for imaging a three-dimensional object (22) as an object image (30), which comprises an imaging system, especially a microscope for imaging the object (22) and a computer. Actuators change the position of the object (22) in the x, y and z direction in a specific and rapid manner. A recording device records an image stack (26) of individual images (24) in different focal levels of the object (22). A control device controls the hardware of the imaging system, and an analytical device produces a three-dimensional relief image (28) and a texture (29) from the image stack (24). A control device combines the three-dimensional elevation relief image (28) with the texture (29).

The invention relates to a method for depicting a three-dimensional object according to the generic part of claim 1 as well as to a device for this purpose according to the generic part of claim 17.

Known devices of this type such as microscopes, macroscopes, etc. make use of physical laws in order to examine an object. In spite of the availability of good technology, it is still necessary to accept limitations in terms of the sharpness and depth, viewing angle and time dependence.

A wide array of devices and methods already exist which are aimed at improving the depth of focus and the physical limits of microscopy imaging methods. Examples of such devices are all kinds of optical microscopes. This also includes, for instance, a confocal microscope. In this case, a specimen is scanned point-by point in a plane with the focus of a light beam, so that an image of this image plane is obtained, although with only a small depth of field. By recording several different planes and appropriately processing the images, the object can then be imaged three-dimensionally. Such a confocal scanning microscope method is known, for example, from U.S. Pat. No. 6,128,077. The optical components employed in confocal scanning microscopy, however, are very expensive and, in addition to requiring sophisticated technical knowledge on the part of the operator, they also entail a great deal of adjustment work.

Furthermore, U.S. Pat. No. 6,055,097 discloses a method for luminescence microscopy. Here, a specimen is marked with dyes that are fluorescent under suitable illumination conditions, so that the dyes in the specimen can be localized by the irradiation. In order to generate a spatial image, several images are recorded in different focal planes. Each one of these images contains image information stemming directly from the focal plane as well as image information stemming from spatial sections of the object that lie outside of the focal plane. In order to obtain a sharp image, the image components that do not stem from the focal plane have to be eliminated. For this purpose, the suggestion is made to provide the microscope with an optical system that allows the specimen to be illuminated with a special illumination field, for instance, a stationary wave or a non-periodic excitation field. Due to the restricted depth of focus of the imaging method, these familiar microscopic images are optically limited, and so is their depiction owing to the modality of observation, that is to say, the viewing angle. Microscopic images can be partially unsharp. This unsharpness can be explained, among other things, by non-planar objects since the object surface often does not lie completely in the focal plane in question. Moreover, in conventional imaging systems, the object viewing direction dictated by the microscope or macroscope does not allow any other object viewing angle (e.g. tangentially relative to the object surface) without the need for another tedious preparation and readjustment of the object itself.

With all of these optical methods, the imaging precision is restricted by a limitation of the depth of focus.

The non-prior-art DE 101 49 357.6 describes a method and a device for generating a three-dimensional surface image of microscopic objects in such a way as to achieve depth of field. For this purpose, the surface profile of the object is optically measured in a three-dimensional coordinate system (x, y, z). With this method, a CCD camera is employed to make a digital or analog recording of different focal planes of a microscopic object. Hence, an image is generated for each focal plane, thus yielding an “image stack”. This image stack is made up of images that stem from the various focal planes of an object lying stationary under the microscope during the recording. Each of these images in the image stack contains areas of sharp image structures having high sharpness of detail as well as areas that were outside of the focal plane during the recording of the image and that are consequently present in the image in an unsharp state and without high sharpness of detail. Hence, an image can be regarded as a set of partial image areas having high sharpness of detail (in focus) and having low sharpness of detail (out of focus). Image-analysis methods are then employed to extract the partial image areas having high sharpness of detail from each image of the image stack. A resulting image then combines all of the extracted subsets of each image having high sharpness of detail to form a new, overall image. The result is a new, completely detail-sharp image.

Since the relative position of the focal planes with respect to each other is known from which the subsets of each image having high sharpness of detail stem, the distance of the images in the image stack is likewise known. Therefore, a three-dimensional surface profile of the object being examined under the microscope can also be generated.

Consequently, in order to obtain an image having depth of field as well as a three-dimensional surface reconstruction of the recorded object area, there is a need for a previously acquired image sequence from various focal planes.

Up until now, the focal plane has been changed by adjusting the height of the microscope stage, in other words, by varying the distance between the object and the lens by mechanically adjusting the specimen stage. Due to the considerable weight of the stage and the resultant inertia of the overall system, it was not possible to drop below certain speed limitations for recording images in several focal planes.

In this context, the non-prior-art DE 101 44 709.4 describes an improved method and an improved apparatus for quickly generating precise individual images of the image stack in the various focal planes by means of piezo actuators in conjunction with methods controlled by stepping motors and/or servo-motors. With this method, the focal planes can be adjusted by precisely and quickly changing the distance between the lens and the object, and the position of the object in the x, y planes can be adjusted by various actuators such as piezo lenses, piezo specimen stages, combinations of piezo actuators and standard adjustments by stepping motors, but also by means of any other adjustments of the stage. The use of piezo actuators improves the precise and fine adjustment. Moreover, piezo actuators increase the adjustment speed. This publication also describes how the suitable incorporation or deployment of de-convolution techniques can further enhance the image quality and the evaluation quality.

However, such surfaces that have been scanned by means of automatically adjustable object holders do not allow a view having depth of field of the overall surface of the object itself. A three-dimensional depiction of the entire scanned area is not possible either. Moreover, the depiction cannot be spatially rotated or observed from different viewing angles.

Therefore, the objective of the present invention is to propose a method and a device for generating optical-microscopic, three-dimensional images, which function with simple technical requirements and concurrently yield an improved image quality in the three-dimensional depiction.

This objective is achieved by means of a method for depicting a three-dimensional object having the features according to claim 1 as well as by means of a device having the features according to claim 10.

According to the invention, an image stack is acquired from a real object, and said image stack consists of optical-microscopic images. By means of a suitable process, especially a software process, a surface relief image is acquired from the image stack and it is then combined with a texture in such a way that an image of the object is formed. In order to combine the texture with the elevation relief image, it is particularly advantageous to project a texture onto the elevation relief image. Here, the texture can once again be acquired from the data of the image stack.

Thus, with this method, a virtual image of a real object can be created that meets all of the requirements that are made of a virtual image. This object image can also be processed by means of the manipulations that are possible with virtual images. Generally speaking, in virtual reality, an attempt is made to use suitable processes, especially those that have been realized in a computer program, in order to image reality as accurately as possible using virtual objects that have been appropriately computed. Ever more realistic simulations of reality can be created on the computer through the use of virtual lamps and shadow casting, through the simulation of physical laws and properties such as settings of the refractive index, simulation of elasticity values of objects, gravitation effects, tracing a virtual light beam in virtual space under the influence of matter, so-called ray tracing, and many other properties.

Normally, the scenarios and sequences are generated by the designer completely anew in purely virtual spaces, or else existing resources are utilized. With the present invention, in contrast, a real imaging system, especially a microscope, is employed in order to generate the data needed to create a virtual image of reality. This data can then be processed in such a way that a virtual, three-dimensional structure can be automatically depicted. A special feature in this context is that an elevation relief is acquired from the real object and this relief is then provided with a texture that is preferably ascertained on the basis of the data obtained from the object. Here, particularly good results are achieved with the projection of the texture onto the elevation relief image.

Therefore, an essential advantage of the invention can be seen to lie in the fact that, through the use of the method according to the invention, conventional optical microscopy and optical macroscopy are expanded in that the raw data such as, for example, statistical three-dimensional surface information or unsharp image information that has been acquired by means of real light imaging systems such as optical microscopes or optical macroscopes, is combined to form a new image. Thus, all or any desired combination or subset of the partial information acquired under real conditions can be displayed simultaneously.

Another advantage consists in the fact that multifocus images computed individually or consecutively so as to have depth of field are merged with the likewise acquired, corresponding three-dimensional surface information. This merging process is effectuated in that the multifocus image having depth of field is construed as the surface texture of a corresponding three-dimensional surface. The merging process is achieved by projecting this surface texture onto the three-dimensional surface.

Consequently, the new, three-dimensional virtual image obtained according to the invention contains both types of information simultaneously, namely, the three-dimensional surface information and the completely sharp image information. This image depiction can be designated as “virtual reality 3D optical microscopy” since the described merging of data cannot be performed in “real” microscopes.

The process steps described in greater detail above can be carried out in order to generate the image stack, which consists of individual images that are taken in different focal planes of the object. For this purpose, especially the method disclosed in the German publication DE 101 49 357.6 can be employed to generate a three-dimensional surface reconstruction. This reconstruction is provided by two data records in the form of an image. One data record encodes the elevation information of the microscopic object and will be referred to hereinafter as a mask image.

The second data record constitutes a high-contrast microscopic image having complete depth of field and will be referred to hereinafter as a multifocus image. This multifocus image is generated using the mask image in that the grayscale values of the mask image are employed to identify the plane of an extremely sharp pixel and to copy the corresponding pixel of the plane in the image stack into a combined multifocus image.

As described above, for example, the process steps as disclosed in DE 101 44 709.4 are such that they use piezo technology with lenses and/or specimen stages and they scan the object over fairly large areas in the appertaining focal plane (x, y directions) in order to generate mask images and multifocus images having a high resolution in the direction of the focal planes (z direction).

Therefore, the mask image contains the elevation information while the multifocus image contains the pure image information having depth of field. The mask image is then employed to create a three-dimensional elevation relief image (pseudo image). This is created by depicting the mask image as an elevation relief. The pseudo image does not contain any direct image information other than the elevation information. Consequently, the three-dimensional pseudo image constitutes a so-called elevation relief. In another step, the three-dimensional pseudo image is provided with the real texture of the sharp image components of the image stack. In order to do so, the pseudo image and the mask image are appropriately aligned, namely, in such a way that the elevation information of the pseudo image and the image information of the mask image, that is to say, the texture, are superimposed over each other with pixel precision. In this manner, each pixel of the multifocus-texture image is imaged precisely onto its corresponding pixel in the three-dimensional pseudo image, so that a virtual image of the real object is created.

The optical microscopic methods for imaging objects commonly employed up until now are restricted by a wide array of physical limitations when it comes to their depiction capabilities. The invention largely eliminates these limitations and provides users with many new possibilities to examine and depict microscopic objects.

For purposes of employing the invention, a suitable user surface can also be defined that allows users to make use of the invention, even without having special technical knowledge. Moreover, the invention can also be utilized for three-dimensional depictions of large surfaces. By imaging microscopic or macroscopic image information that has been acquired under real conditions into a “virtual reality space”, commonly employed microscopes gain access to the full technology of virtual worlds. The images formed provide microscopic imaging that is considerably clearer and more informative than conventional optical microscopy, thus allowing users to employ all other imaging methods and manipulation methods of virtual reality known so far.

The virtual image does not have any sharpness limitation of the kind encountered in normal object images due to the restricted depth of focus of the lens system employed. Therefore, the imaging is completely sharp. The virtual imaging concurrently contains the complete depth information. Thus, a completely sharp, three-dimensional, true-to-nature virtual image of a real microscopic object is created.

In a preferred embodiment of the invention, the imaging can be realized virtually in a computer. Every possibility of image depiction and manipulation that can be used for virtual images is available. These options range from the superimposition of surfaces acquired under real microscopy conditions and purely virtual surfaces all the way to the possibility of obtaining a view at any desired angle onto a three-dimensional surface having depth of field. The surfaces can be virtually animated, illuminated or otherwise modified. Time dependencies such as changes to the surface of the microscopic object over the course of time can be simultaneously imaged with image information having depth of field and three-dimensional surface topologies.

Therefore, completely new possibilities are opened up in the realm of optical microscopy, which compensate for restrictions in the image quality due to physical limitations.

The following components are employed in an advantageous embodiment of the invention:

1. a microscope with the requisite accessories (lenses, etc.) or another suitable imaging system such as, for example, a macroscope;

2. a computer with suitable accessories such as monitor, etc.;

3. actuators for targeted, rapid changing of the position of an object in the x, y and z directions such as, for instance, a piezo, a stepping motor stage, etc.;

4. a camera, especially an analog or digital CCD camera, with requisite or practical accessories such as a grabber, fire wire, hot link, USB port, Bluetooth for wireless data transmission, network card for image transmission via a network, etc.;

5. a control device to control the hardware of the microscope, especially the specimen stage, the camera and the illumination;

6. an analysis device to generate the multifocus images, the mask images, the mosaic images and to create the “virtual reality 3D optical microscopic images”. Control and analysis methods are preferably implemented by means of software;

7. a means to depict, compute and manipulate the generated “virtual reality 3D optical microscopic images” such as, for example, rotation in space, changes in illumination, etc. Once again, this is preferably implemented by means of depiction software.

Thus, software implemented in a computer controls the microscope, the specimen stage in the x, y and z directions, optional piezo actuators, illumination, camera imaging, and any other microscope hardware. The procedure to generate the mask images and multifocus images and to create a “virtual reality 3D microscopic image” can also be controlled by this software.

The use of a piezo-controlled lens or of a piezo-controlled lens holder or else the combination of a piezo-controlled lens with a piezo-controlled lens holder translates into a very fast, reproducible and precise positioning of an object in all three spatial directions. In combination with the image-analytical methods that enhance the depth of field and the possibilities for 3D reconstruction, a fast, 3D reconstruction of microscopic surfaces can be achieved. Moreover, image mosaics can be quickly generated whose sharpness has been computed and which can also create a dimensional surface profile. The individual images are taken by a suitable CCD camera. Moreover, unfolding the individual images with a suitable apparatus profile before the subsequent sharpness computation and 3D reconstruction makes it possible to generate high-resolution microscopic images that have been corrected with respect to the apparatus profile and that have a high depth of focus.

In another advantageous embodiment of the invention, several image stacks are recorded sequentially. The above-mentioned conversion of these sequential individual images of the image stack into consecutive virtual-reality 3D images allows three-dimensional, completely sharp imaging of time sequences in animated form such as, for example, in a film.

Another advantageous embodiment of the invention is obtained by employing so-called morphing, a process in which several images in an animation are merged into each other. This is an interpolation between images in such a way that, on the basis of a known initial image and a known final image, additional, previously unknown intermediate images are computed. By then lining up the initial image, the intermediate images and the final image and by playing the known and the interpolated images consecutively, the impression is created of a continuous transition between the initial image and the final image.

Through morphing, the described process can be accelerated in that only a few images have to be recorded under real conditions of time and space. All other images needed for a virtual depiction are computed by means of the interpolation of intermediate images.

A special advantage of the present invention for generating a “virtual reality 3D optical microscopic image” is that it employs real data from optical-microscopic imaging systems such as optical microscopes or optical macroscopes. In this context, care should be taken to ensure that distortions caused by the imaging optical system of optical macroscopes are first rectified mathematically. According to the invention, the virtual reality is generated automatically, semi-automatically or manually on the basis of the underlying real data. Another advantage of the invention is the possibility to carry out any desired linking of the acquired data of “virtual reality 3D optical microscopy” with prior-art techniques of virtual reality, namely, the data that has been generated purely virtually, that is to say, without the direct influence of real physical data.

Another advantage of the invention is the possibility of carrying out 3D measurements such as, for instance, volume measurements, surface measurements, etc., with the data from “virtual reality 3D optical microscopy”.

Another advantageous embodiment of the invention offers the possibility of projecting image-analytically influenced and/or altered texture images onto the 3D surface, as described above. In this manner, further “expanded perception” is made possible by “virtual reality 3D optical microscopy” since the altered textures are projected onto the 3D surface in their true location. This makes it possible to connect and simultaneously depict image-analytical results with three-dimensional surface data. This also holds true for image-analytically influenced time series of images in the sense above.

Another advantage of the invention lies in using the method for mosaic images, so that defmed partial areas of the surface of an object are scanned. These partial images are compiled so as to have depth of field and, in addition to the appertaining 3D object surface data, they are computed to form a “virtual reality 3D optical microscopic image” of the scanned-in object surface.

The invention—in terms of its advantages—is especially characterized in that it allows a considerable expansion of the perception of microscopic facts on the object. This is achieved by simultaneously depicting a completely sharp image on a three-dimensional surface obtained by microscopy. As a result of the virtual 3D reality of the microscopic image and also the compatibility of the virtual depiction with standard programs and processes, it is possible to integrate all of the knowledge and all of the possibilities that have been acquired so far in the realm of virtual reality.

The images generated with the method according to the invention match the actual conditions in the specimen more closely than images that are obtained with conventional microscopes. After all, the “virtual reality 3D optical microscopic image” provides not only complete sharpness but also the three-dimensional information about the object.

Moreover, the “virtual reality 3D optical microscopic image” can be observed from various solid angles by rotating the image into any desired position. In addition, the object image can be manipulated as desired by means of transparencies and other standard methods in order to emphasize or de-emphasize other microscopic details.

The informative value and a three-dimensional depiction of a microscopic object that comes much closer to human perception open up completely new horizons for analytical methods. Image mosaics which are depicted as a “virtual reality 3D optical microscopic image” additionally expand the depiction capabilities.

The possibility of full automation of the cited sequences for generating a “virtual reality 3D optical microscopic image” or several “virtual reality 3D optical microscopic images” by means of automatic time series do not make particularly high demands of the technical know-how of the user.

Combinations of the “virtual reality 3D optical microscopic image”, which was generated from basic data recorded under real conditions, with the possibilities of superimposing purely virtual objects such as platonic basic bodies or other, more complex bodies, yield new didactic possibilities for the dissemination of knowledge. The combination of the data of the “virtual reality 3D optical microscopic image” with a pair of 3D cyberspace glasses permits viewing of microscopic objects with a precision and completeness not known up until now.

Since the data of the “virtual reality 3D optical microscopic image” can be stored in a computer, this data can be displayed on other systems, it can be transmitted via computer networks such as the Intranet or Internet, and the “virtual reality 3D optical microscopic image” can be depicted via a web browser. Moreover, three-dimensional image analysis is possible.

Virtual microscopy, that is to say, microscopy by users “without” a microscope, in other words, only on the basis of the acquired and/or stored “virtual reality 3D optical microscopic image data” allows a separation of the real microscopy and the evaluation of the acquired data.

Conventional standard optical microscopes with standard illumination can be employed to generate the 3D image according to the invention, thus rendering this process inexpensive.

Additional advantages and advantageous embodiments of the invention are the subject matter of the following figures and their descriptions whereby, for the sake of clarity, the depiction of these figures was not rendered to scale.

The drawings show the following:

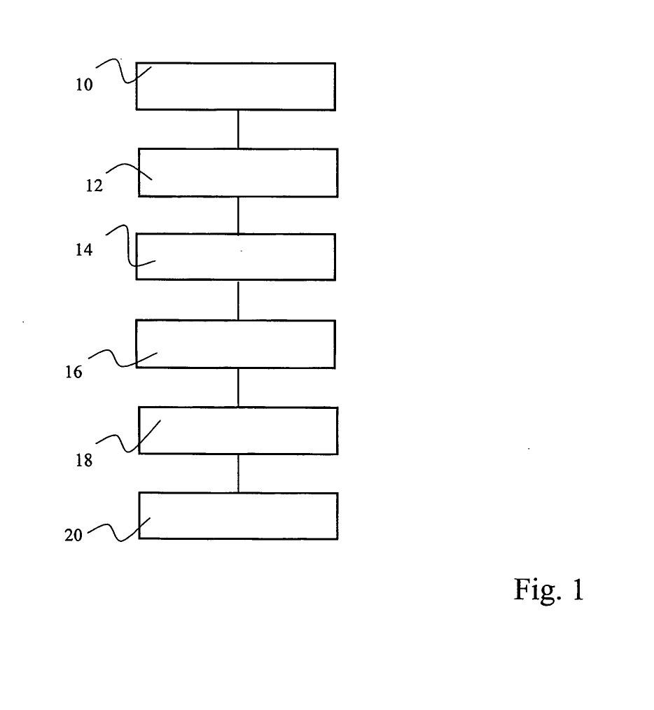

FIG. 1—a schematic sequence of the method according to the invention;

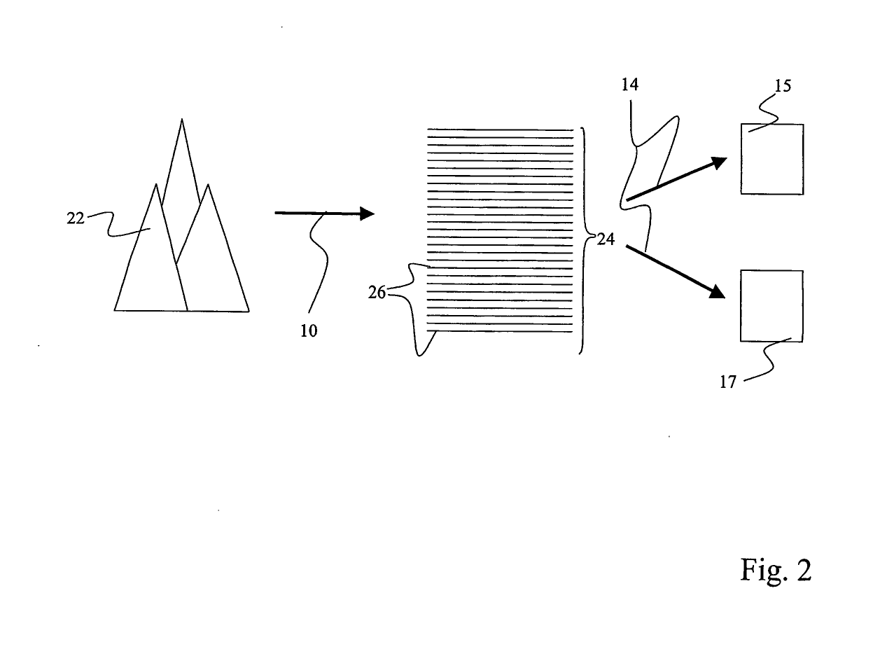

FIG. 2—a schematic sequence of the method according to the invention with reference to an example;

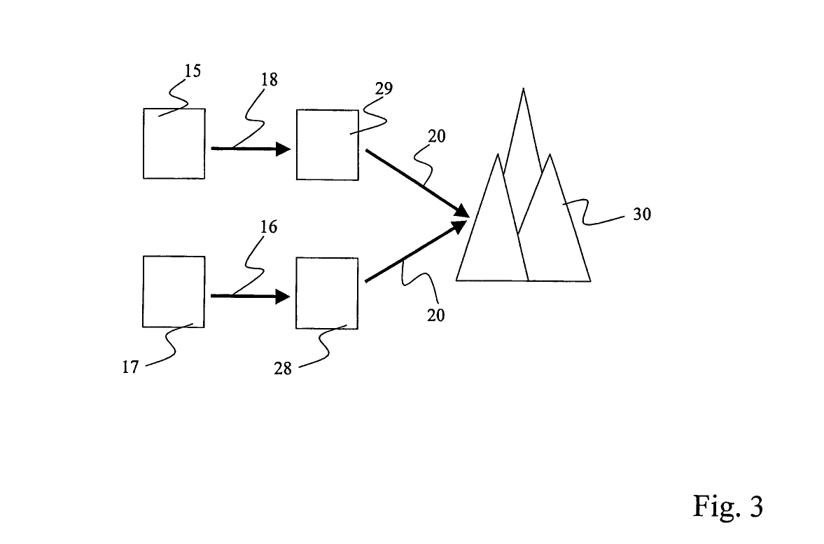

FIG. 3—a schematic sequence of the method according to the invention with reference to an example;

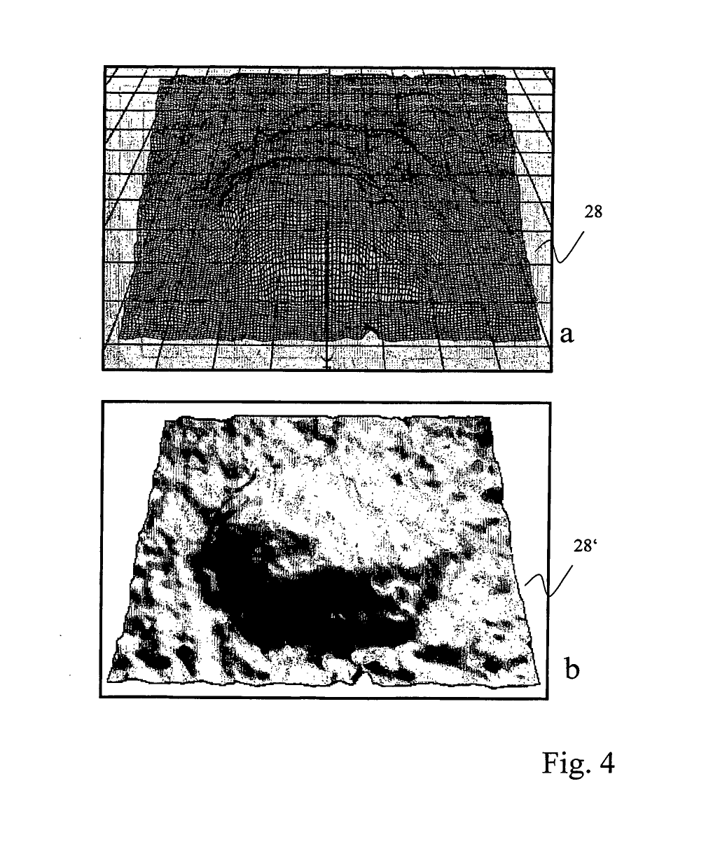

FIG. 4a—example of a pseudo image;

FIG. 4b—example of a structured pseudo image;

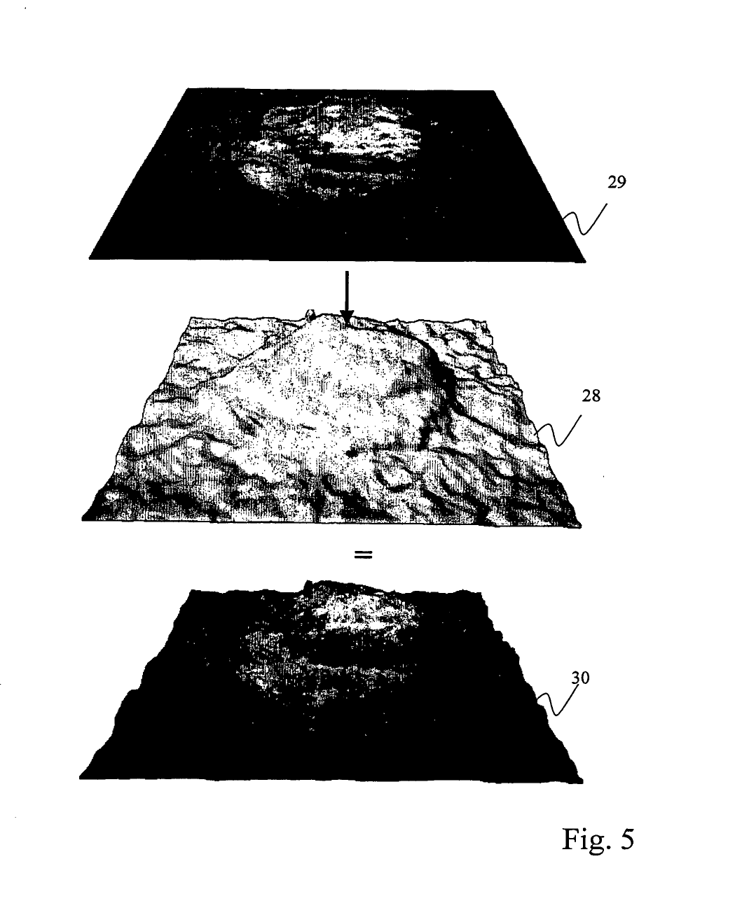

FIG. 5—combination of a texture with a pseudo image with reference to an example;

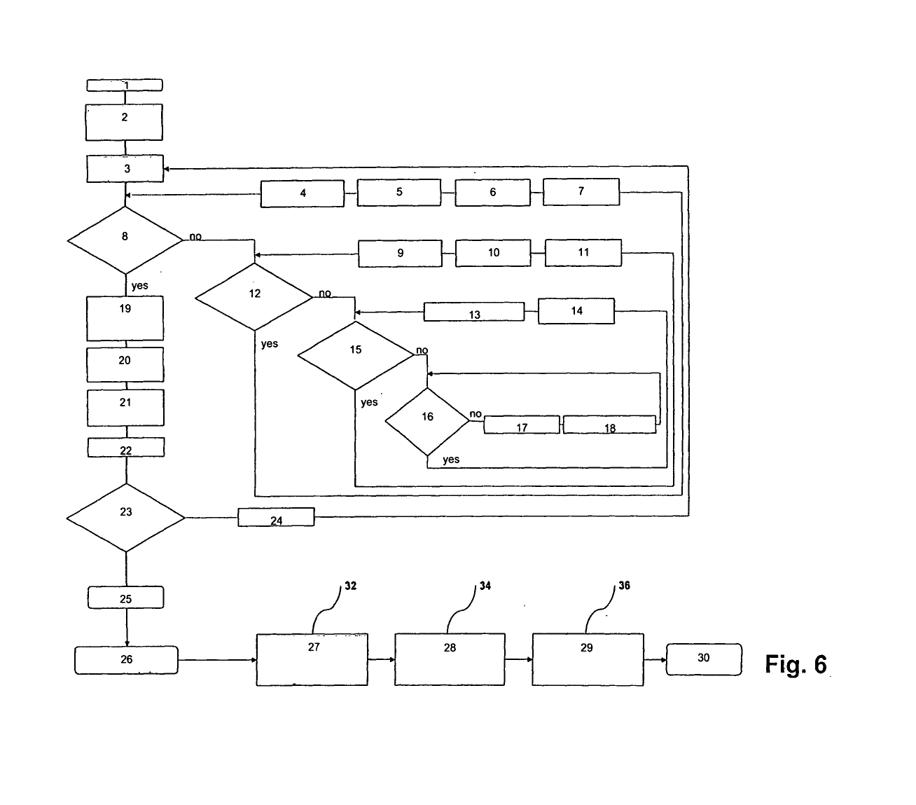

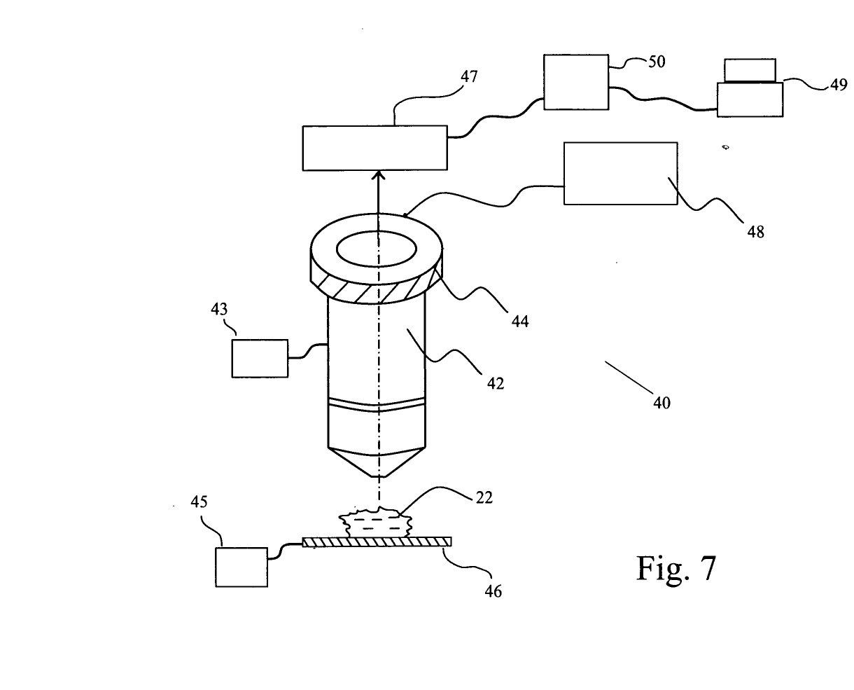

FIG. 6—schematic automatic process sequence.

FIG. 1 schematically shows the fundamental sequence of the method according to the invention, which is illustrated once again in FIGS. 2 and 3 with reference to a schematic example. Starting with an object 22 (FIG. 2), an image stack 24 is created in process step 10 by manually or fully automatically recording individual images 26 from multiple focal planes of the object 22. The distance of the individual images is appropriately dimensioned in order to allow the reconstruction of a three-dimensional image having depth of field and this distance is preferably kept equidistant. Each individual image 26 has sharp and unsharp areas, whereby the image distance and the total number of individual images 26 are known. After being recorded, in process step 12, the images are first stored in uncompressed form or else stored in compressed form by means of a compression procedure that does not cause any data loss. The individual images 26 can be color images or grayscale images. The color or grayscale resolution (8-bit, 24-bit, etc.) can have any desired value.

When the image stack is created, the procedure can be such that several images lie next to each other in a focal plane (in the x, y directions) and are compiled once again with pixel precision so that a so-called mosaic image of the focal plane is formed. Here, it is also possible to create an image stack 24 on the basis of the mosaic images. Once an individual image has been recorded in every desired focal plane (z plane), the result is an image stack 24 having a series of individual images 26 that are ready for further image processing. Preferably, the z planes are equidistant from each other.

In order to create the image stack 24, an imaging system can be employed, in which case especially a microscope or a macroscope is used. However, a properly secured camera system with a lens can also be utilized. The entire illumination area of a specimen ranging from the near UV light to the far IR light can be used here, provided that the imaging system permits this.

Generally speaking, the recording system can comprise any analog or digital CCD camera, whereby all types of CCD cameras, especially line cameras, color cameras, grayscale cameras, IR cameras, integrating cameras, cameras with multi-channel plates, etc. can all be deployed.

In another process step 14, a multifocus image 15 and a mask image 17 are then obtained from the acquired data of the image stack 24, whereby here in particular the methods according to DE 101 49 357.6 and DE 101 44 709.4 can be employed. Owing to the depth of focus of the microscope, each individual image 26 has sharp and unsharp areas. According to certain criteria, the sharp areas in the individual images 26 are ascertained and their plane numbers are associated with the corresponding coordinate points (x, y). The association of plane numbers and coordinate points (x, y) is stored in a memory and this constitutes the mask image 17. When the mask image 17 is processed, the plane numbers stored in the mask image can be construed as grayscale values.

In the multifocus image 15, all of the unsharp areas of the individual images of the previously recorded and stored image stack 24 have been removed, so that a completely sharp image having depth of field is obtained. The multifocus image (15) can also be made from a mosaic image stack in such a way that several mosaic images from various focal planes are computed to form a multifocus image (15).

In the mask image 17, all grayscale values of the pixels indicate the number of the plane of origin of the sharpest pixel. Thus, the mask image can also be depicted as a three-dimensional elevation relief 28. The three-dimensionality results from the x, y positions of the mask image pixels and from the magnitude of the grayscale value of one pixel, which indicates the focal plane position of the three-dimensional data record. The mask image 17 can also be made from a mosaic image stack, whereby several mosaic images from different focal planes are computed to form the mask image 17.

Now that the mask image 17 has been acquired, a so-called three-dimensional pseudo image 28 can be created from it. For this purpose, in process step 16, the mask image 17 is depicted as an elevation relief. Aside from the elevation information, this image does not contain any direct image information. The mask image 17 is imaged here as a dimensional elevation relief by means of suitable software. This software can be developed, for instance, on the basis of the known software libraries OpenGL or Direct3D (Microsoft). Moreover, there are other likewise suitable commercially available software packages for depicting, creating, animating and manipulating 3D scenes such as Cinema 4D (manufactured by the Maxon company), MAYA 3.0, 3D Studio MAX or Povray.

So-called splines are employed to generate this depiction. Splines are essentially sequences of reference points that lie in the three-dimensional space and that are connected to each other by lines. Splines are well known from mathematics and are technically used for generating three-dimensional objects. In a manner of speaking, they constitute elevation lines on a map. The reference points are provided by the grayscale values of the mask image in such a way that the coordinates (X, Y, Z) of the reference points for a spline interpolation correspond to the following mask image data:

reference point coordinate X corresponds to the mask image pixel coordinate X

reference point coordinate Y corresponds to the mask image pixel coordinate Y

reference point coordinate Z corresponds to the grayscale value at X, Y of the mask image 17.

The course of the spline curves is determined by so-called interpolation. Here, the course of the spline curves is calculated by means of interpolation between the reference points of the splines (polynomial fit of a polynomial of the nth order by a prescribed number of points in space such as, for instance, by Bezier polynomials or Bernstein polynomials, etc.), so that the spline curves are formed. Depending on the type of interpolation function employed and on the number of reference points, more or less detail-rich curve adaptations to the given reference points can be made. The number of reference points can be varied by taking only a suitably selected subset of mask image points rather than considering all of the mask image points as reference points for splines. Here, for example, every fourth pixel of the mask image 17 can be used. A subsequent interpolation between the smaller number of reference points would depict the object surface at a lower resolution. Therefore, the adaptation of the number of reference points creates the possibility of depicting surfaces with a varying degree of detail, thus filtering out various surface artifacts. Consequently, fewer reference points bring about a smoothing effect of the three-dimensional surface.

In the present invention, the previously computed mask image forms the reference point database. The reference points lie in a 3D space and thus have to be described by three spatial coordinates. The three spatial coordinates (x, y, z) of each reference point for splines are formed by the x, y, z pixel positions of the mask image pixels and by the grayscale value of each mask pixel (z position). Since the grayscale values in a mask image correspond to the elevation information of the underlying microscopic image anyway, the 3D pseudo image can be interpreted as a depiction of the elevation course of the underlying microscopic image.

Thus, by prescribing an array of reference points containing all or a suitable subset of the mask image points and mask image point coordinates, a spline network of a selectable density can be laid over the reference point array. A three-dimensional pseudo image 28 obtained in this manner is shown in FIG. 4a.

As shown in FIG. 4b, appropriate triangulation and shading procedures such as, for example, so-called Gouraud shading, make it possible to lay a fine structure over this surface. Moreover, through the use of ray tracing algorithms, surface reflection and shadow casting can yield surfaces 28′ that already appear very realistic.

Furthermore, the three-dimensional pseudo image 28 has to be linked with a texture 29. Here, the term texture refers to a basic element for the surface design of virtual structures when the envisaged objective is to impart the surfaces with a natural and realistic appearance. In this manner, in process step 18, a texture 29 is created on the basis of the previously prepared multifocus image 15. For this purpose, the previously computed multifocus image 15 having depth of field is now employed, for instance, as a texture image.

In order to incorporate the rest of the acquired information—which is especially present in the multifocus image 15—into the three-dimensional pseudo image 28, in process step 20, the three-dimensional pseudo image 28 is now linked to the texture 29 as shown in FIGS. 1 to 3.

The term texture 29, as is common practice in virtual reality, refers here especially to an image that is appropriately projected onto the surface of a virtual three-dimensional object by means of three-dimensional projection methods. In order to achieve the desired effect, the texture image has to be projected onto the surface of virtual objects so as to be appropriately aligned. For purposes of attaining a suitable alignment, the texture 29 has to be associated with the three-dimensional pseudo image 28 in such a way that the associations of the pixel coordinates (x, y) of the mask image 17 and of the multifocus image 15 are not disturbed. Thus, each mask pixel whose grayscale value is at the (xᵢ, yⱼ) location is associated with its corresponding multifocus pixel whose grayscale value is at precisely the same (xᵢ, yⱼ) location. If the multifocus image 15 has been previously changed by image analytical processes or by other image manipulations, care should be taken not to lose the associations of the pixel coordinates (x, y) of the mask image and of the multifocus image that has been altered in some way by image analytical processes or other manipulations do not get lost in the process.

Advantageously, the texture 29 is thus appropriately projected onto the three-dimensional pseudo image 28 in order to link the pseudo image 28 with the texture 29. This makes it possible to merge the two resources in such a way that the result is a three-dimensional object image 30 of the object 22. This object image 30 constitutes a virtual imaging in the sense of virtual reality.

As is shown in the example according to FIG. 5, the basis for the texturing according to the invention is formed by the multifocus image itself, which has been previously computed. The pseudo image 28, which already looks quite realistic, and the mask image 17 are properly aligned, namely, in such a way that the elevation information of the pseudo image 28 and the image information of the mask image 17, that is to say, the texture, lie over each other with pixel precision. The multifocus texture image, that is to say, the texture 29, is projected onto the three-dimensional pseudo image 28 so that each pixel of the multifocus texture image 29 is imaged precisely onto its corresponding pixel in the three-dimensional pseudo image 28. Thus, the merging of virtual and real imaging techniques yields an object image 30 of the object 22 that has depth of field and that is present as a virtual image.

With the sequence of the method shown schematically in FIGS. 1 to 3, the novel imaging according to the invention is based on values of a really existent object 20 that have been measured under real conditions and that have been combined in such a way as to bring about virtually real three-dimensional imaging of the optical microscopic data. In comparison to conventional virtual techniques, the present invention makes use of a real recording of an object 22. Data on the image sharpness, on the topology of the object and on the precise position of sharp partial areas of an image in three-dimensional space is recorded about the real object 22. This real data then serves as the starting point for generating a virtual image in a three-dimensional space. Consequently, the virtual imaging procedure that acquires—and simultaneously images—data such as image information, sharpness and three-dimensionality from the real images constitutes a definite improvement over conventional optical microscopy.

According to the invention, a new type of optical microscopy is thus being proposed whose core properties are the acquisition of real, for example, optical microscopic object data, and its combined depiction in a three-dimensional virtual space. In this sense, the invention can be designated as “virtual reality 3D optical microscopy”. Moreover, in this “virtual reality 3D optical microscope”, the images of the reality (3D, sharpness, etc.) can also be influenced by means of all known or yet to be developed methods and processes of virtual imaging technology.

Since the preceding embodiment described the manual and fully automatic generation of a “virtual reality 3D optical microscopic image”, another embodiment will describe a method for the visualization, manipulation and analysis of the “virtual reality 3D optical microscopic images”.

For purposes of visualizing the object image 30 data on the basis of the transformation of real microscopic data in a virtual space, the microscopic data of the object image 30 is now present in the form of three-dimensional images having depth of field.

Virtual lamps can then illuminate the surface of the object image 30 in order to visually highlight certain details of the microscopic data. The virtual lamps can be positioned at any desired place in the virtual space and the properties of the virtual lamps such as emission characteristics or light color can be flexibly varied.

This method allows the creation of considerably better and permanently preserved microscopic images for teaching and documentation purposes.

The images can be rotated and scaled in the space at will using rotation and translation operators. This operation allows the observation of the images at viewing angles that are impossible with a normal microscope.

Moreover, by incrementally shifting the orientation of a “virtual reality 3D optical microscopic image” and by storing these individual images, animation sequences can be created that simulate a movement of the “virtual reality 3D optical microscopic image”. By storing these individual images as a film sequence (for example, in the data formats AVI, MOV, etc.), these animation sequences can then be played back.

Moreover, the data can also be manipulated. The imaging of the three-dimensional pseudo image is present as reference points for three-dimensional spline interpolation. Gouraud shading and ray tracing can then be employed to associate a surface that appears to be three dimensional with this three-dimensional data.

The x, y, z reference points play a central role in the data manipulation that can be employed, for example, for measuring purposes or to more clearly highlight certain details.

Multiplying the z values by a number would translate, for example, into an elongation or a compression of the elevation relief. By systematically manipulating the individual reference points, certain parts of the 3D profile of the three-dimensional pseudo image 28 can be manipulated individually.

By means of image-analytical manipulations of the projected multifocus texture image, it is also possible to project image-analytical results such as the marking of individual image objects, edge emphasis, object classifications, binary images, image enhancements, etc. This is done by employing an image-analytically altered initial image (multifocus texture image) as a new “manipulated” multifocus texture image and by projecting the new image as texture onto the three-dimensional surface of the 3D pseudo image. In this manner, image-analytically manipulated images (new textures) can also be merged with the three-dimensional pseudo image.

Thus, possibilities exist for 3D manipulation such as, for instance, the manipulation of the reference points for the spline interpolation as well as for manipulation of the multifocus image by means of image-analytical methods.

The merging of these two depictions can enhance the microscopic image depiction since the object images 30, aside from the three-dimensional depiction, also comprise a superimposition of the image-analytically manipulated multifocus images in their true location.

Due to the transformation of the data of the real object 22 into data present in a virtual space, the three-dimensional data can now be measured in terms of its volume, its surface or its roughness, etc.

Another improvement allows the combination of the measured results obtained with the multifocus image by means of image analysis with the three-dimensional data measurements. Moreover, logical operations of the three-dimensional data with other appropriate three-dimensional objects then make it possible to perform a plurality of computations with three-dimensional data.

Thus, through the mere modality of the depiction, the two-dimensional image analysis is expanded by a third dimension of image analysis and by a topological dimension of data analysis.

By recording time series, that is to say, by recording images of the object 22 at various consecutive points in time according to the described method, an additional dimension for data analysis is added, namely, the time dimension. This then makes it possible to depict a time process, for instance, the change of an object 22 over the course of time, either in slow motion or in time lapse.

The method according to the invention is also suitable for generating stereo images and stereo image animation. Since the data of the object image 30 is present in three-dimensional form, two views of a virtual microscopic image can be computed from any desired viewing angle. This allows a visualization of the “virtual reality 3D optical microscopic image” in the sense of a classical stereo image.

Aside from being displayed on a monitor, output by a printer or a plotter, the “virtual reality 3D optical microscopic image” can also be visualized by a polarization shutter glass or with anaglyph techniques or through imaging using 3D cyberspace glasses.

Through the animation with separate perspectives for the right eye and for the left eye and through a series of different views of the “virtual reality 3D optical microscopic image”, one of the above-mentioned visualization methods can then serve to generate a moving stereo image of a “virtual reality 3D optical microscopic image” generated on the basis of real microscopic data.

Since the data is present in three-dimensional form, a view of the “virtual reality 3D optical microscopic image” can be computed whose perspective is correct for the right eye and for the left eye. In this manner, the “virtual reality 3D optical microscopic images” can also be output on 3D output devices such as 3D stereo LCD monitors or cyberspace glasses.

With a 3D LCD stereo monitor, image analysis is employed to measure the current position of the eyes of the observer. This data then serves to compute the particular viewing angle. This then yields the data for a perspective view of the “virtual reality 3D optical microscopic image” for the right eye and for the left eye of the observer. These two perspectives are computed and displayed on the 3D LCD stereo monitor. Thus, the observer gains the impression that the “virtual reality 3D optical microscopic image” is floating in space in front of the monitor. In this manner, microscopic data acquired under real conditions can be imaged in such a way that a spatially three-dimensional imaging of reality is created. Moreover, spatially animated three-dimensional imaging of real microscopic images can also be realized through image sequences that are correct in terms of time and perspective.

In the case of cyberspace glasses, for technical reasons, one image is presented separately to each eye in the correct perspective view. From this, the brain of the observer generates a three-dimensional impression. Moreover, here too, spatially animated three-dimensional imaging of real microscopic images can also be effectuated through image sequences that are correct in terms of time and perspective.

In another embodiment of the invention, it is possible to combine the data obtained from “virtual reality 3D optical microscopy” with each other in such a way that even processes that change over the course of time can be animated and visualized in “virtual reality 3D optical microscopy”. In addition to the three spatial coordinates X, Y, Z, it is also possible to manipulate data relating to the texture 29-pure, sharply computed image information of the object (multifocus image) or relating to changes in the surface and/or the texture over the course of time (time series of images).

Like with the methods described so far, changes in microscopic objects over the course of time can also be detected by repeatedly recording the same image stack in the z direction (in the direction of the optical axis of the imaging system) at various points in time. This produces a series of image stacks that corresponds to the conditions in the object 22 at different points in time. Here, the three-dimensional microscopic surface structures as well as the microscopic image data themselves can change over the course of time.

A time series of the same microscopic area each time produces a series of consecutive mask images and the appertaining multifocus images in such a way that

mask [t₁]→mask [t₂]. . .→mask [tₙ]→mask [t_{n+1]}

and thus

multifocus [t₁]→multifocus [t₂]. . .→multifocus [tₙ]→multifocus [tₙ₊₁]

In the case of changes in the topology over the course of time, it applies that

mask [tₙ] is not equal to mask [tₙ₊₁]{n=1, 2, 3, 4, . . .}

and for image changes, it applies that

multifocus [tₙ] is not equal to multifocus [t_{n+1]{n=}1, 2, 3, 4, . . .}

These time series can be generated both manually and automatically.

Recording time sequences of mosaic multifocus images and the appertaining mosaic mask images also makes it possible to obtain time-related kinetics of surface changes and/or image changes.

As shown in FIG. 6, the process sequence for generating an animation can be integrated into the process sequences known from DE 101 49 357.6 and DE 101 44 709.4, so that a fully automated sequence can also be realized. For this purpose, the process sequence already known from these two publications is augmented by additional process steps that can be automated. If the process sequence for the creation of a virtual reality object image 30 is started, then in step 32, a virtual reality object image 30 can be generated as described above. This object image 30 can be animated as desired in step 34. Preferably, the animated image is stored in step 36. In this manner, mosaic images, mask images and mosaic-multifocus images are generated and stored at certain points in time. These mask and multifocus images then serve as the starting point for a combination of the appertaining mask and multifocus images.

In a second step, the masks and multifocus images that belong together can be combined to form individual images in “virtual reality 3D optical microscopy”.

Thus, a time series of individual “virtual reality 3D optical microscopic images” is created. Each image simultaneously contains the 3D information of the mask image and the projected texture of the multifocus image. The individual images can differ in case of changes over time in the object 22 but also in the three-dimensional topological appearance and/or in changes in the texture 29.

Arranging the individual images consecutively allows a time-related animation of the images with the possibilities of “virtual reality 3D optical microscopy”.

Thus, three-dimensional surface information, changes in the surfaces over time, multifocus images computed so as to have depth of field and changes over time in these multifocus images can all be depicted simultaneously.

The requisite mask images 17 and multifocus images 15 can also be construed as a mosaic mask image and as a mosaic multifocus image that have been created by repeatedly scanning a surface of the object 22 at specific points in time.

Rotating these “virtual reality 3D optical microscopic” images makes it possible to observe the simultaneously imaged features such as three-dimensional surface information, changes in the surfaces over time, multifocus images computed so as to have depth of field and changes in these multifocus images over time, also at different viewing angles. For this purpose, the data record that describes a three-dimensional surface is subjected to an appropriate three-dimensional transformation.

In summary, the described imaging achieved with “virtual reality 3D optical microscopy” can be regarded as the simultaneous imaging of five dimensions of microscopic data of an object 22. In this context, the five dimensions are:

X, Y, Z—pure three-dimensional surface information about the object 22;

the texture 29, in other words, sharply computed image information of the object 22;

the changes in the surface and/or the texture over time as a time series of images.

### LIST OF REFERENCE NUMERALS

10 generation of an image stack of an object

12 storage of the images of the image stack

14 generation of a multifocus image and of a mask image

15 multifocus image

16 generation of a three-dimensional pseudo image

17 mask image

18 preparation of a texture

20 linking of the texture with the pseudo image

22 object

24 image stack

26 individual image of a focal plane

28 three-dimensional pseudo image

28′ three-dimensional pseudo image with a surface structure

29 texture

30 object image

32 generation of a virtual reality image

34 creation of an animation

36 storage of the image

1-20. (canceled).

21. A method for depicting a three-dimensional object, the method comprising:
acquiring from the object an image stack including a plurality of images, each image being in a respective focal plane;
generating a three-dimensional elevation relief image from the image stack; and
combining the three-dimensional elevation relief image with a texture so as to depict the three-dimensional object as an object image.

22. The method as recited in claim 21 wherein the combining is performed by projecting the texture onto the three-dimensional elevation relief image.

23. The method as recited in claim 21 wherein the generating is performed using data of the plurality of images and further comprising providing the texture using the data of the plurality of images.

24. The method as recited in claim 21 wherein the generating is performed by connecting a plurality of reference points using interpolation so as to form an elevation line.

25. The method as recited in claim 22 wherein the projecting is performed by aligning the texture onto the three-dimensional elevation relief image with pixel precision.

26. The method as recited in claim 21 further comprising changing the three-dimensional elevation relief image before the combining:

27. The method as recited in claim 26 wherein the changing is performed by providing the three-dimensional elevation relief image with a virtual surface using at least one of a triangulation, a shading and a ray tracing algorithm.

28. The method as recited in claim 21 further comprising providing the texture using data of a multifocus image, the multifocus image including information of the object having depth of field.

29. The method as recited in claim 21 wherein the generating is performed using data of a mask image including respective elevation information of the respective focal planes.

30. The method as recited in claim 24 further comprising altering the three-dimensional elevation relief image using at least one of elongation and compression of the reference points before or after the combining.

31. The method as recited in claim 21 further comprising image-analytically manipulating the object image.

32. The method as recited in claim 31 wherein the manipulating is performed by combining the object image with a second texture.

33. The method as recited in claim 31 further comprising manipulating data relating to the texture so as to provide a virtually changed image.

34. The method as recited in claim 31 further comprising manipulating data relating to changes in the texture over time so as to provide a virtually changed image.

35. The method as recited in claim 31 further comprising manipulating data relating to changes in the texture over time so as to provide a time series of images in a virtual reality manner.

36. The method as recited in claim 31 further comprising manipulating data relating to changes in a surface of the three-dimensional elevation relief image over time so as to provide a virtually changed image.

37. The method as recited in claim 31 further comprising manipulating data relating to changes in a surface of the three-dimensional elevation relief image over time so as to provide a time series of images in a virtual reality manner.

38. The method as recited in claim 21 wherein:
the acquiring includes recording the plurality of images; and
the combining is started manually or automatically after the recording.

39. The method as recited in claim 21 further comprising repeating the acquiring, generating and combining steps so as to provide a plurality of consecutive object images.

40. The method as recited in claim 21 further comprising outputting the object image on an output device.

41. The method as recited in claim 40 wherein the output device includes at least one of a monitor, a plotter, a printer, an LCD monitor and cyberspace glasses.

42. The method as recited in claim 21 further comprising:
outputting the object image; and
changing the object image before the outputting.

43. The method as recited in claim 21 wherein the changing is performed by at least one of illuminating the object image with a virtual lamp, processing the object image using rotation or translation operators, and subjecting the object image to virtual physical laws.

44. The method as recited in claim 21 further comprising:
repeating the acquiring, generating and combining steps so as to provide a plurality of object images; and
outputting the plurality of object images on an output device as a time sequence of the object images.

45. The method as recited in claim 44 wherein the time sequence of the object images has a form of a film or animation.

46. The method as recited in claim 44 further comprising merging the plurality of object images into each other using morphing.

47. An apparatus for depicting a three-dimensional object as an object image comprising:
an imaging system;
at least one first actuator configured to change a position of the object in a z direction in a targeted, rapid manner;
a recording device configured to record an image stack including a plurality of images, each respective image being in a respective focal plane of the object; and
an analysis device configured to generate a three-dimensional elevation relief image and a texture from the plurality of images of the image stack, and to combine the three-dimensional elevation relief image with the texture.

48. The apparatus as recited in claim 47 further comprising a first control device configured to control the at least one first actuator.

49. The apparatus as recited in claim 47 further comprising at least one second actuator configured to change a position of the object in at least one of an x and a y direction.

50. The apparatus as recited in claim 49 further comprising a second control device configured to control the at least one second actuator.

51. The apparatus as recited in claim 49 wherein the first control device is configured to control the at least one second actuator.

52. The apparatus as recited in claim 49 wherein the first control device is configured to control hardware of the imaging system.

53. The apparatus as recited in claim 47 further comprising a third control device configured to control hardware of the imaging system.

54. The apparatus as recited in claim 47 wherein the analysis device includes a computing device.

55. The apparatus as recited in claim 54 wherein the computing device is configured to control the at least one first actuator.

56. The apparatus as recited in claim 54 wherein the computing device is configured to control the hardware of the imaging system.

57. The apparatus as recited in claim 47 wherein the imaging system includes a microscope configured to image the object.

58. The apparatus as recited in claim 47 wherein the recording device includes at least one of an analog and a digital CCD.

59. The apparatus as recited in claim 47 further comprising an output device configured to output the object image.

60. The apparatus as recited in claim 59 wherein the output device includes at least one of a monitor, a plotter, a printer, an LCD monitor and cyberspace glasses.

61. The apparatus as recited in claim 47 where in the analysis device includes a first analysis sub-device configured to generate the three-dimensional elevation relief image and a texture from the plurality of images of the image stack, and a second analysis sub-device configured to combine the three-dimensional elevation relief image with the texture.

62. The apparatus as recited in claim 47 where in the analysis device is configured to perform data analysis of the object image.
